(19) United States
(12) Patent Application Publication
(10) Pub. No.: US 2020/0348931 A1
(43) Pub. Date: Nov. 5, 2020

(54) DYNAMIC SOURCE CODE ENTITIES CATEGORIZATION AND RANKING BASED ON BASIS PATH AND GRAPH LINKAGES

(71) Applicant: EMC IP HOLDING COMPANY LLC, HOPKINTON, MA (US)

(72) Inventors: Mohammad Rafey, Bangalore (IN); Chetan Somaiah, Bangalore (IN)

(73) Assignee: EMC IP HOLDING COMPANY LLC, HOPKINTON, MA (US)

(21) Appl. No.: 16/402,335

(22) Filed: May 3, 2019

(51) Int. Cl. G06F 8/77; G06F 16/28; G06F 16/901

(52) U.S. Cl. CPC G06F 8/77; G06F 16/9024; G06F 16/285

(57) ABSTRACT

Implementing dynamic categorization and ranking of source code entities and relationships is provided. An aspect includes scanning source code of an application, extracting source code entities from the application, and generating a hierarchical source code entity graph model from extracted source code entities. An aspect also includes scanning a project management artifact repository, extracting project management artifacts from the project management artifact repository, and generating a hierarchical project management artifact graph model from extracted project management artifacts. An aspect further includes traversing the hierarchical source code entity graph model and the hierarchical project management artifact graph model, identifying linking relationships between the source code entities and the project management artifacts, defining a policy for software quality control from the linking relationships, monitoring source code changes to the application, and modifying source code development for the application when a violation of the policy is identified in response to the monitoring.

### BACKGROUND

In today's software source code base, there are hundreds or thousands of entities (e.g., Modules, Classes, Functions or Methods). A typical software system may run for months or years in production. In terms of code basis paths, not all paths are executed all the times. Based on n-number of variable factors such as conditions, interlocks, dependencies or rules, the system chooses the execution flow at runtime and does so dynamically. Over a period of time, it can be generalized that some parts of the code base are executed or utilized more frequently than other parts in terms of basis paths. It can also be generalized the importance of source code entities based on its linkages with other source code entities and project work items.

Currently, there are no tools that can categorize and rank source code entities such as Classes or Functions or Methods based on their actual runtime usage and business importance. Code optimization efforts are equally distributed over the entire code which is not efficient. As a result a greater than desired amount of time may be spent on optimizing portions of code that are not executed very often. Oftentimes, test case writing efforts may also be diluted due to equal distribution of effort in writing and maintaining it. The same may happen for code coverage and logging efforts.

### SUMMARY

This Summary is provided to introduce a selection of concepts in a simplified form that are further described herein in the Detailed Description. This Summary is not intended to identify key features or essential features of the claimed subject matter, nor is it intended to be used to limit the scope of the claimed subject matter.

One aspect may provide a method for dynamic categorization and ranking of source code entities and relationships. The method includes scanning source code of an application, extracting source code entities from the application, and generating a hierarchical source code entity graph model from extracted source code entities. The method also includes scanning a project management artifact repository, extracting project management artifacts from the project management artifact repository, and generating a hierarchical project management artifact graph model from extracted project management artifacts. The method further includes traversing the hierarchical source code entity graph model and the hierarchical project management artifact graph model, identifying linking relationships between the source code entities and the project management artifacts, defining a policy for software quality control from the linking relationships, monitoring source code changes to the application, and modifying source code development for the application when a violation of the policy is identified in response to the monitoring.

Another aspect may provide a system for dynamic categorization and ranking of source code entities and relationships. The system includes a memory having computer-executable instructions. The system also includes a processor operated by a storage system. The processor executes the computer-executable instructions. When executed by the processor, the computer-executable instructions cause the processor to perform operations. The operations include scanning source code of an application, extracting source code entities from the application, and generating a hierarchical source code entity graph model from extracted source code entities. The operations also include scanning a project management artifact repository, extracting project management artifacts from the project management artifact repository, and generating a hierarchical project management artifact graph model from extracted project management artifacts. The operations further include traversing the hierarchical source code entity graph model and the hierarchical project management artifact graph model, identifying linking relationships between the source code entities and the project management artifacts, defining a policy for software quality control from the linking relationships, monitoring source code changes to the application, and modifying source code development for the application when a violation of the policy is identified in response to the monitoring.

Another aspect may provide a computer program product for dynamic categorization and ranking of source code entities and relationships. The computer program is embodied on a non-transitory computer readable medium. The computer program product includes instructions that, when executed by a computer at a storage system, causes the computer to perform operations. The operations include scanning source code of an application, extracting source code entities from the application, and generating a hierarchical source code entity graph model from extracted source code entities. The operations also include scanning a project management artifact repository, extracting project management artifacts from the project management artifact repository, and generating a hierarchical project management artifact graph model from extracted project management artifacts. The operations further include traversing the hierarchical source code entity graph model and the hierarchical project management artifact graph model, identifying linking relationships between the source code entities and the project management artifacts, defining a policy for software quality control from the linking relationships, monitoring source code changes to the application, and modifying source code development for the application when a violation of the policy is identified in response to the monitoring.

### BRIEF DESCRIPTION OF THE DRAWINGS

Objects, aspects, features, and advantages of embodiments disclosed herein will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features. For clarity, not every element may be labeled in every figure. The drawings are not necessarily to scale, emphasis instead being placed upon illustrating embodiments, principles, and concepts. The drawings are not meant to limit the scope of the claims included herewith.

FIG. 1 is a block diagram of a system architecture for modeling dynamic relationships between project source code entities and project management entities in accordance with an illustrative embodiment;

FIG. 2A is a hierarchical graph model of source code entities in undirected cyclic graph (UCG) format in accordance with an illustrative embodiment;

FIG. 2B is a hierarchical graph model of project management entities in UCG formal in accordance with an illustrative embodiment;

FIG. 3 depicts the models of FIGS. 2A-2B with linkages in accordance with an illustrative embodiment;

FIG. 4 is a flow diagram of a process for modeling dynamic relationships between project source code entities and project management entities in accordance with an embodiment;

FIG. 5 is a block diagram of a system architecture for implementing dynamic source code categorization and ranking based on basis path and graph linkages in accordance with an embodiment;

FIG. 6 is a table of basis path metrics from application logs with metric scores in accordance with an embodiment;

FIG. 7 is a table of source code entities and scores calculated from source code entity linkages to other source code entities in accordance with an embodiment;

FIG. 8 is a table of source code entities and scores calculated from source code entity linkages to project work items in accordance with an embodiment;

FIG. 9 is a flow diagram of a process for categorizing and ranking source code entities in accordance with an embodiment;

FIG. 10 is a table depicting categorized source code entities in accordance with an embodiment;

FIG. 11 is a table depicting source code entity rankings in accordance with an embodiment; and

FIG. 12 is a block diagram of an illustrative computer and apparatus that can perform at least a portion of the processing described herein.

### DETAILED DESCRIPTION

Embodiments described herein provide an intelligent automated system that categorizes application source code entities in a ranking hierarchy, based on its importance and usage over the duration of application execution. The system correlates the source code entities, such as classes, functions, methods, and test cases with project management work items, such as themes, features, stories, tasks, and defects.

The importance determination above may be measured in terms of graph based in/out referencing to other source code entities and graph based in/out referencing to project work items. The usage may be measured in terms of basis paths and code execution hits at application runtime. The system of the embodiments herein is described as based on Basis Paths, Page Rank, Graph Theory Principles, and Finite Undirected Cyclic Graphs.

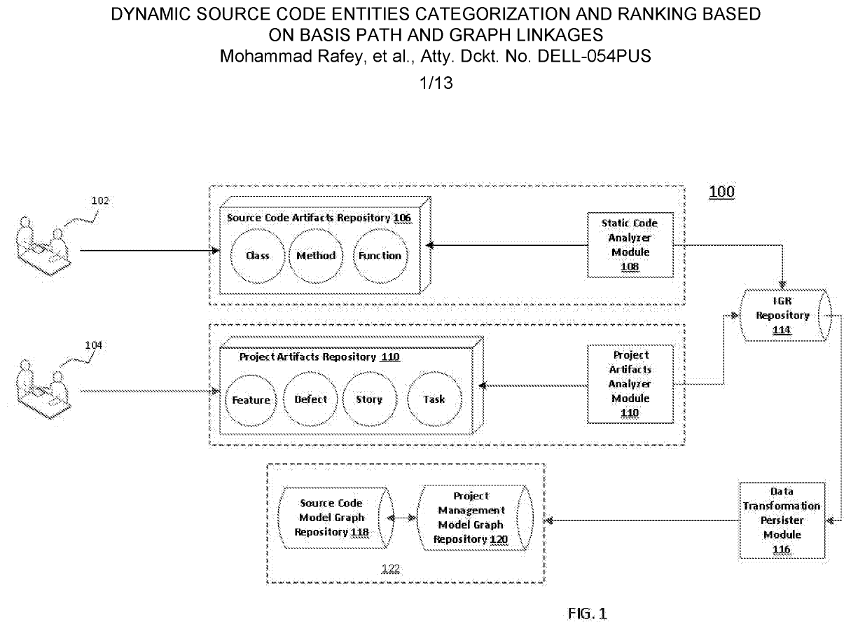

Turning now to FIG. 1, an example system 100 for modeling dynamic relationships between project source code entities and project management entities will now be described.

The system 100 of FIG. 1 includes a source code artifacts repository 106 communicatively coupled to a static code analyzer module 108. The system 100 also includes a project artifacts repository 110 communicatively coupled to a project artifacts analyzer module 112.

In an embodiment, the static code analyzer module 108 integrates with the source code base in version control such as Team Foundation Server (TFS) by MICROSOFT to scan/probe application modules. The static code analyzer module 108 may leverage C#.NET & .NET Reflection APIs. In embodiments, the static code analyzer module 108 performs code analysis and parsing. In particular, the module 108 extracts types (e.g., classes), functions, and methods defined in application modules (e.g., EXE/DLL). The analyzer module 108 also builds Intermediate Graph Representation (IGR) models, e.g., using a tree data structure, and persists the IGR models in a database, e.g., (a Graph or No-SQL DB). In particular, the IGR models are stored in an IGR repository 114.

In an embodiment, the project artifacts analyzer module 112 integrates with source control using, e.g., VSTS Team Foundation REST APIs and Azure DevOps Services to analyze and extract management work items such as Themes, Features, Stories, Defects, Tasks, Changesets and their inter-linkages. The project artifacts analyzer module 112 scans and extracts all TFS Themes, Features, Stories, Tasks and Defects in a defined scope based on, e.g., Organization, Team, Project or Collections. The project artifacts analyzer module 112 also extracts all the changes made to a source code base in terms of check-ins and Changesets. It then finds classes and functions that have been modified in those Changesets. The analyzer module 112 further identifies relationships between modified Classes/Functions tagged to Tasks and Defects, which in turn are tagged to respective Features and Stories. Further, the project artifacts analyzer module 112 builds intermediate graph representation (IGR) models from the projects artifacts based on, e.g., a tree data structure, and persists the IGR models in a database (e.g., a Graph or No-SQL DB). As shown in FIG. 1, the database is provided as the IGR repository 114.

In an embodiment, a project development team 102 makes changes to source code entities via the repository 106. The static code analyzer module 108 scans source code in the repository 106 and extracts entities, such as class and functions. The module 108 builds the IGR models from the extracted information, which may be stored in the IGR repository 114 in FIG. 1.

A project management team 104 defines, creates, and tracks changes to project entities, which are stored in the project artifacts repository 110. The project artifacts analyzer module 112 scans the repository 110 and extracts entities, such as features, defects, stories, and tasks, and builds the IGR from the extracted information, which is stored in repository 114.

Also shown in FIG. 1 is a data transformation persister module 116, a source code model graph repository 118 and a project management model graph repository 120. The source code model graph repository 118 and the project management model graph repository are collectively referred to as UCG repository 122.

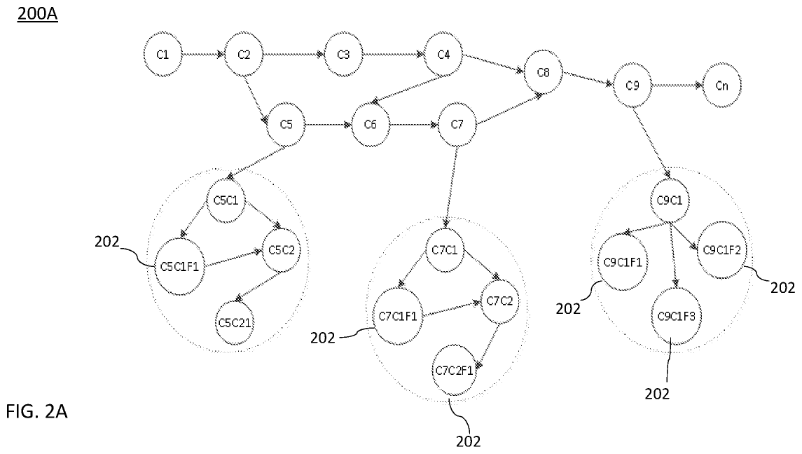

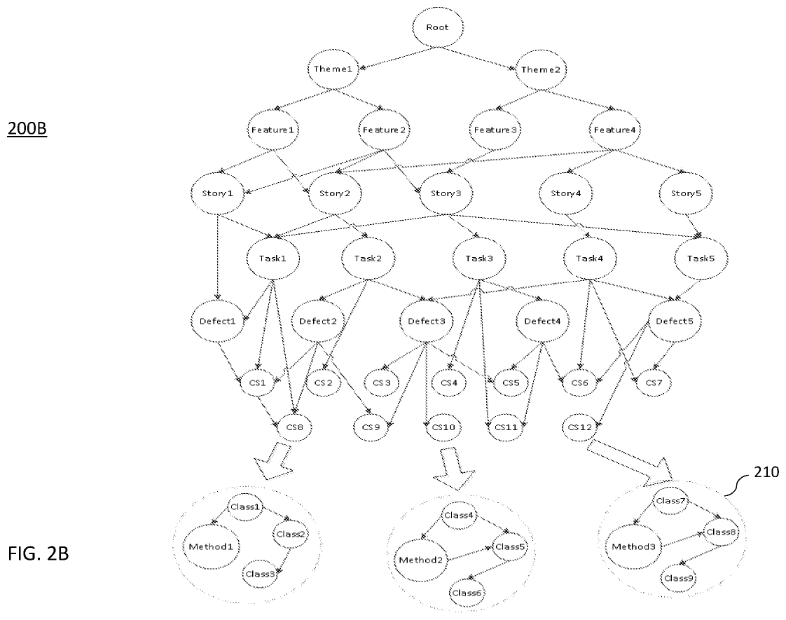

The data transformation and persister module 116 reads the IGR models generated as described above, and transforms them into Undirected Cyclic Graph (UCG) models (e.g., as shown and described in FIGS. 2A-2B). The data transformation and persister module 116 may be implemented in Python to support graph structures and associated operations. The data transformation and persister module 116 may leverage Python graph packages, such as NetworkX or Graph-Tool to perform graph model transformations. The UCG models are stored in the respective repositories 118 and 120.

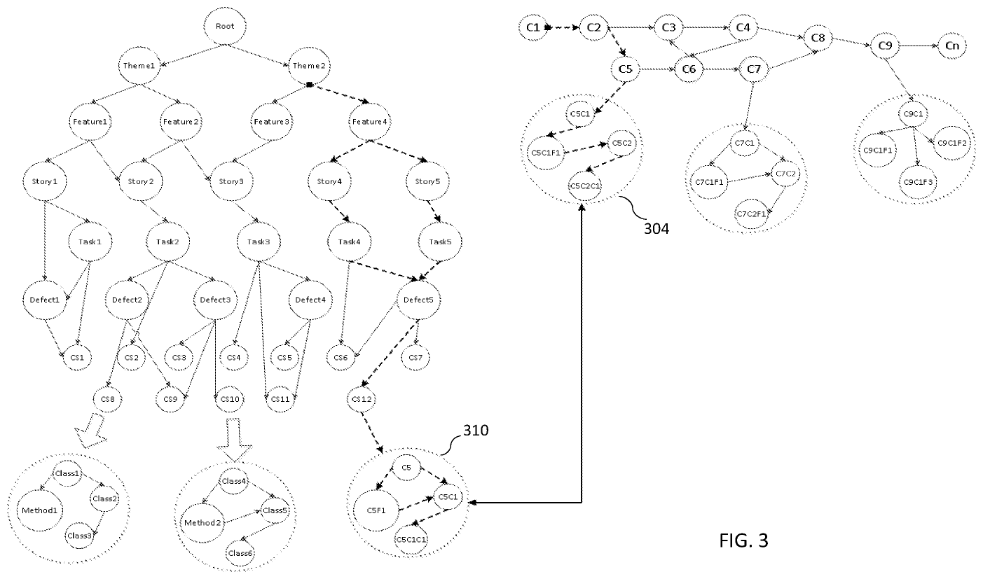

The UCG models are accessed and scanned and all changesets are extracted, and scan/extract all Changesets which provide the list of Classes, Functions and Methods modified as part of that Changeset. The Changeset on the other side will be linked to Tasks->Story-Features->Theme. Using a reverse graph traversal, the system can relate a Class to a Feature (e.g., as shown in the graph models 300 of FIG. 3). Once the UCG model is generated, it is persisted in a database. As shown in FIG. 1, the UCG model is persisted in source code graph model graph repository 118 and project management graph model graph repository 120.

FIG. 2A illustrates a sample source code UCG model 200A, and FIG. 2B illustrates a sample management work item UCG model 200B.

In particular, graph model 200A represents a hierarchical graph model of source code artifacts (also referred to as source code entities graph model) generated by the static code analyzer module 108 shown in UCG format. Objects 202 are functions or methods found in the source code base, while all other objects (e.g., C1-Cn and C5C1, C5C2, C5C21, C7C1, C7C2, and C9C1) depicted in 200A represent classes or types. The UCG can be expressed as an n-node graph G=(N,E) with n Nodes and n−1 Edges where:

1≤|N|≤ [symbol] 1 and 0≤|E| [symbol] 1.

G is an ordered pair and is an undirected cyclic graph.

N={n₁, n₂, n₃, n₄, n₅, n₆, n₇, n₈, n₉, nₙ}

E={{n₁,n₂},{n₂,n₃},{n₃,n₄},{n₄,n₅},{n₅,n₆},{n₆,n₇},{n₇,n₈},{n₈,n₉},{nₙ₋₁,nₙ}}

Thus, a node (e.g., n1) may correlate to node C1 in FIG. 2A, a node (e.g., n2) may correlate to node C2 in FIG. 2A, and an edge (e.g., n1,n2) may correlate to an edge between nodes C1 and C2.

Graph model 200B of FIG. 2B represents a hierarchical graph model of project management entities (also referred to herein as project work items graph model) generated by project artifacts analyzer module 112. The system links the source code entities to the respective project management entities graph via changeset entities (e.g., 204/210), which act as bridges between the two disjoint sets.

As shown in FIG. 3 (e.g., through the dotted lines/edges between nodes), based on the graph models 200A and 200B, the system can link: Class C1, C2, C5, function C5C1F1 (from the source code entities graph model) are linked to Defect5, Task4, Task5, Story4, Story5 and Feature4 (of the project work items graph model). In addition, Feature4, Story4, Story5, Task4, Task5, and Defect5 (from the project work items graph model) are linked to Class C1, C2, C5, and Function C5C1F1 (of the source code entities graph model). C5C1F1 notation has been used in the source code entities graph model to denote the source code entities relationships, e.g., C5 denotes Class 5, C5F1 denotes Function 1 contained inside Class 5, and C5C1F1 denotes Function 1 contained inside Class 1 which itself is being referred by Class 5. It denotes the object chain which is being used to denote the innermost object.

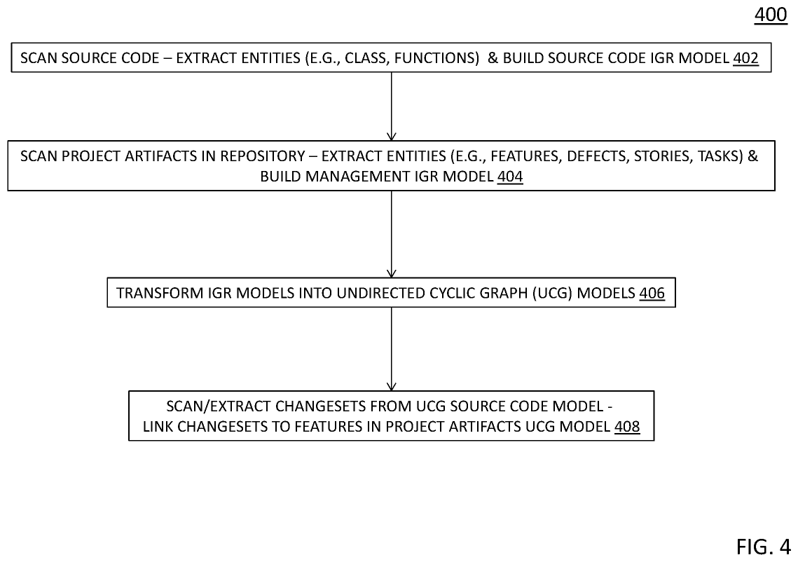

Turning now to FIG. 4, a flow diagram illustrating a process 400 for modeling dynamic relationships between project source code entities and project management entities will now be described. In block 402, a source code entity graph model is built by scanning source code, performing analysis and parsing. Types (classes), functions, and methods defined in application modules (e.g., EXE/DLL) are extracted. In particular, a source code entities IGR model is built, e.g., by the static code analyzer module 108, from scanned/extracted source code base artifacts in the source code artifacts repository 106.

In block 404, a management entity model is built by scanning source controls to analyze and extract management work items (themes, features, stories, defects, tasks, changesets, and their interlinkages). In particular, project management artifacts IGR model is built, e.g., by the project artifacts analyzer module 112 from scanned/extracted artifacts in the project artifacts repository 110. In an embodiment, the project artifacts analyzer module 112 scans and extracts all TFS themes, features, stories, tasks and defects in a defined scope based on Organization, Team, Project, or Collections. It extracts all the changes made to source code base in terms of check-ins and change sets. A check-in refers to the act of making changes in software code and saving it to the source code base. A changeset refers to the set of files being modified in one check-in and is saved to the code base. A changeset may contain one or multiple source code files that have been modified. The project artifacts analyzer module 112 next finds classes and functions that are have modified in these changesets. The module 112 finds relationships between modified classes/functions tagged to tasks and defects, which in turn are tagged to respective feature and stories. The module 112 then builds an IGR graph model based on a tree data structure.

In block 406, the IGR models generated in blocks 402 and 404 are read and transformed into UCG models (e.g., respective graph models 200A-200B in FIGS. 2A-2B). In embodiments, the data transformation persister module 116 performs the transformation.

In block 408, the UCG model is accessed and scanned by the data transformation persister module 116 to extract all the changesets, which provide the list of class, functions, and methods modified as part of that changeset. The changeset on the other side is linked to tasks-story-features-theme. Using reverse graph traversal, the system relates a class to a feature. In particular, the data transformation persister module116 transforms the IGR models to UCG models and extracts the changesets which are linked to changesets on the other side. By way of example, element group 304 shown in FIG. 3 is linked to a changeset 310 of FIG. 3. The changeset 310 is part of the project work item UCG graph model (e.g., shown in FIG. 2B). It contains the list of source code entities that have been modified, such as class, function, method. This is used to link the corresponding source code entities in the source code entities UCG model. Once this link is established, as described in FIG. 3, it can be traversed bi-directionally to track the graph linkages.

As indicated above, the embodiments provide an intelligent automated system that categorizes and builds a ranking hierarchy of application source code entities based on its usage over the duration of application execution and importance based on its linkages to other source code entities and project work item entities. The system correlates the source code entities, such as classes, functions, methods, and test cases with project management work items, such as themes, features, stories, tasks, and defects. In embodiments, the system identifies the part of the code that is used more frequently by analyzing basis path hits at runtime. It assigns scores to each source code entity based on these criteria. The system further identifies how each source code entity is related to other source code entities and project work item entities. It assigns scores to each source code entity based on these criteria.

These scores are monitored and used by the system to determine a final score, which is sued to determine a category and relative rank for each class, function, and method.

Technology leadership and project management teams can define business rules based on the above rankings to enforce organization wide, software quality control and governance policies.

Non-limiting examples of business quality rules and policies include:

Every change in a top 100 Ranking Class/Function/Method has to be code reviewed by the Tech Lead (mandatorily);

Every change in a top 100 Ranking Class/Function/Method has to be unit tested with 100% code coverage before it's checked into source control;

Every change in a top 100 Ranking Class/Function/Method should have 0 compiler warnings;

Every change in a top 100 Ranking Class/Function/Method should have logging enabled at all levels (Error, Debug, Warning and Info);

Every change in a top 300 Ranking Class/Function/Method has to be code reviewed by the Tech Lead (optionally) or peer (mandatorily);

Every change in a top 300 Ranking Class/Function/Method has to be unit tested with at least 70% code coverage before it's checked into source control;

Every change in a top 300 Ranking Class/Function/Method can have warnings ignored;

Every change in a top 300 Ranking Class/Function/Method should have logging enabled at least at Error and Warning; and

Remaining Class/Function/Method might have less severe or stringent policies configured based on business scenario and org requirements.

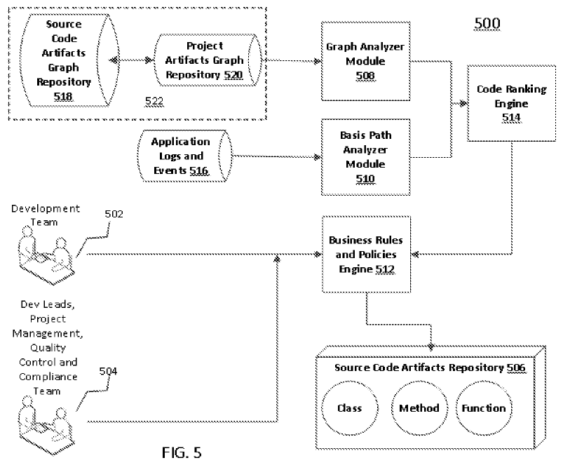

Turning now to FIG. 5, a system 500 for implementing dynamic code rankings based on basis paths and graph linkages will now be described. The system 500 includes components that are the same or substantially similar to those in FIG. 1, e.g., project development team 502 (team 102 of FIG. 1), project management team 504 (team 104 of FIG. 1), source code artifacts repository 506 (repository 106 of FIG. 1), source code artifacts graph repository 518 (repository 108 of FIG. 1), and project artifacts graph repository 520 (repository 120 of FIG. 1), which are collectively referred to as UCG repository 522. The embodiments described further herein utilize the artifacts and graph models of these components, in conjunction with the additional components described in FIG. 5 below, to implement dynamic code rankings based on basis paths and graph linkages.

In addition to the components above, the system 500 of FIG. 5 also includes a graph analyzer module 508, a basis path analyzer module 510, a business rules and policies engine 512, and a code ranking engine 514. The system 500 further includes an application logs and events repository 516.

The basis path analyzer module 510 analyzes application logs and events from repository 516 (or one or more additional repositories, e.g., txt, XML, json files, databases, Splunk) and builds/updates basis path metrics. In particular, the module 510 builds basis path metrics (i.e., the portions of the code that were hit while an application was executed and the frequency of hits). In an embodiment, the scope of measurement is at the Class and Function/Method level. The basis path analyzer module 510 may factor in logs generated over a defined interval of time and runs as a daily job. The module 510 updates the metrics with new information over time. The metrics may be consolidated over a large period of time to ensure confidence in the metrics to predict and differentiate which portions of the code are considered important (e.g., which portions are executed most frequently in comparison to other portions of code). The basis path analyzer module 510 also assigns a score to each and every source code entity found in those basis paths, as will now be described.

Let E={E₁,E₂,E₃,E₄,E₅,E₆,E₇,Eₙ} is the set of source code entities

Let M={M₁,M₂,M₃,M₄,M₅,M₆,M₇,Mₙ} is the set of source entities' occurrences in basis paths

$${n}_{i} = \frac{{M}_{i} - min ( M )}{max ( M ) - min ( M )} ,$$

wherein nᵢ is the ith normalized data and ˜(max(M)−min(M)==0),

nᵢ=0.01 (default normalized score),

where (max(M)−min(M)==0) and (Mᵢ−min(M)==0).

Thus, a sample data and score calculation using the above variables may be: min(O)=25, max(O)=100, and max(O)−min(O)=75.

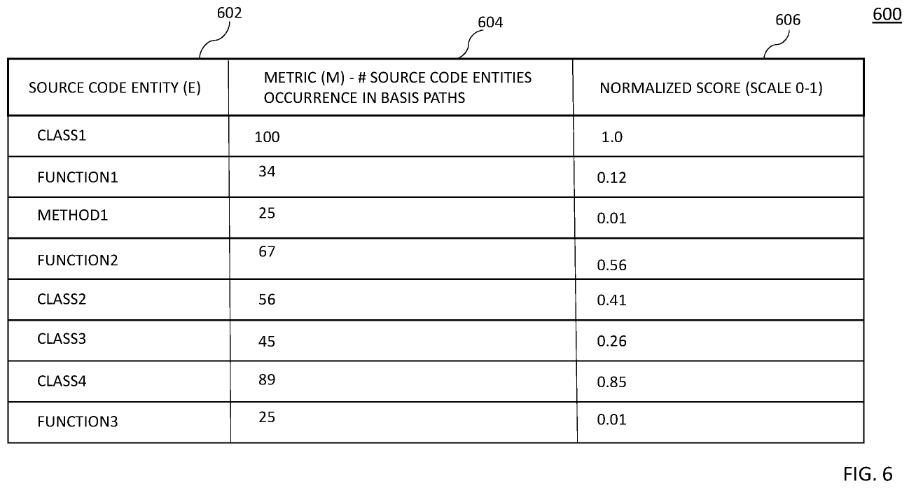

As shown in FIG. 6, a table 600 illustrates some results of the basis path analyzer module 510. The table 600 includes a column 602 that lists the source code entities (E), a column 604 that lists sample metrics (M) including the frequency in which an entity occurs in basis paths, and a column 606 that provides a normalized score (between 0 and 1) for each entity in the table.

Returning to FIG. 5, the graph analyzer module 508 generates metrics similar to the basis path analyzer module, however it utilizes the source code entities graph and project work items graph models (e.g., the graphs shown in FIGS. 2A-2B) from the UCG repository 522. The graph analyzer module 508 generates scores for each source code entity based on two factors: the source code entity's linkages to other source code entities, and the source code entity's linkages to other project work items. Both graph models provide a linking relationship between source code entities and project management entities. It generates metrics, such as, but not limited to: a Class is related by graph edges to how many other source code entities (the more it is being referred in the network, the higher it's score); and a Function or Method is related by graph edges to how many other source code entities (the more it is referred in the network, the higher it's score). Additional details are described further herein.

The graph analyzer module 508 also generates metrics using project management artifacts. The metrics, by way of non-limiting examples, include: a Class is related by graph edges via Changesets nodes to how many other project artifacts like Features, Stories, Tasks or Defects (the more it is being referred in the network, the higher it's score); and a Function or Method is related by graph edges (via Changesets nodes) to how many project work items like Features, Stories, Tasks or Defects (the more it is referred in the network, the higher it's score). Additional details are described further herein.

A page ranking algorithm (e.g., Python NetworkX package PageRank™) may be used to compute these metrics by passing to it the source code and project work item graph models described above. The page ranking algorithm computes a ranking of the nodes in the graph based on the structure of the incoming links and works with both directed as well as undirected graphs.

The system takes a weighted average of the scores and calculates the aggregate score from the graph analyzer module, as will now be described.

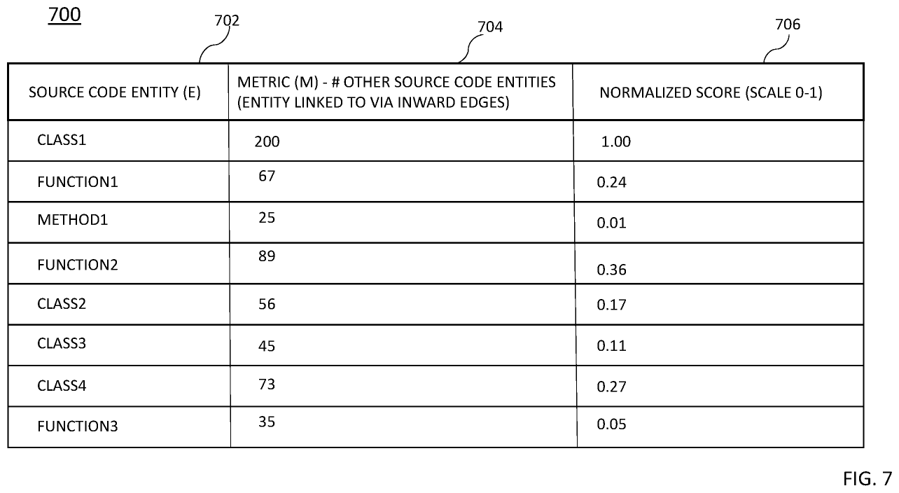

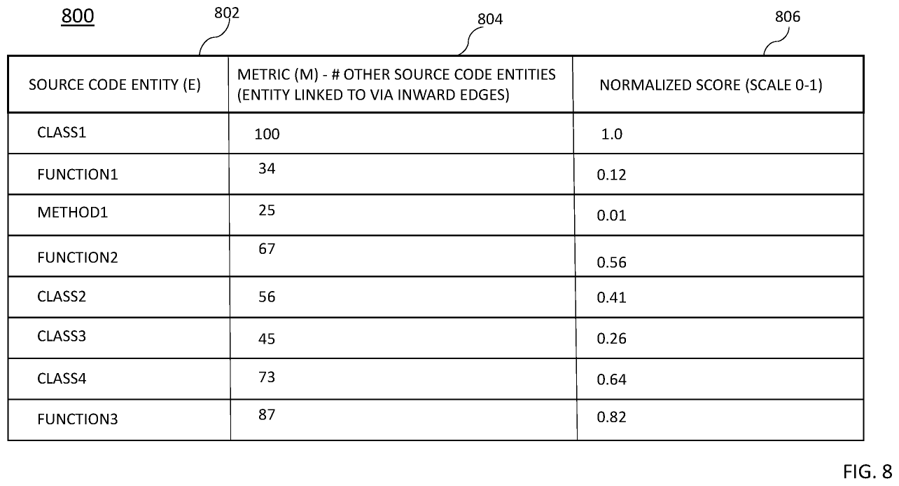

The system calculates scores based on source code entities' linkages and project work items' linkages. Sample scores for the source code entities' linkages is shown in a table 700 of FIG. 7, and sample scores for the project work items' linkages is shown in a table 800 of FIG. 8.

Turning now to the score calculation based on source code entities' linkages:

Let E={E₁,E₂,E₃,E₄,E₅,E₆,E₇,Eₙ} is the set of source code entities

Let M_{sce}={M_{sce1},M_{sce2},M_{sce3},M_{sce4},M_{sce5},M_{sce6},M_{sce7},M_{scen}} is the number of other source code entities, these entities are linked to via inward edges in the source code graph

$${n}_{i} = \frac{{M}_{i} - min ( M )}{max ( M ) - min ( M )} ,$$

wherein nᵢ is the ith normalized data and ˜(max(M)−min(M)==0),

nᵢ=0.01 (default normalized score),

where (max(M)−min(M)==0) and (Mᵢ−min(M)==0).

As shown in FIG. 7, the table 700 includes a column 702 that lists the source code entities (E), a column 704 that lists sample metrics (M) for the number of other source code entities (each of which is linked to via inward edges in the source code graph model), and a column 706 that provides sample normalized scores (between 0 and 1) for each entity in the table.

Turning now to the score calculation based on project work items' linkages:

Let E={E₁,E₂,E₃,E₄,E₅,E₆,E₇,Eₙ} is the set of source code entities

Let M_{pwi}={M_{pwi1},M_{pwi2},M_{pwi3},M_{pwi4},M_{pwi5},M_{pwi6},M_{pwi7},M_{pwin}} is the number of other source code entities, these entities are linked to via inward edges in the source code graph

$${n}_{i} = \frac{{M}_{i} - min ( M )}{max ( M ) - min ( M )} ,$$

wherein nᵢ is the ith normalized data and ˜(max(M)−min(M)==0),

nᵢ=0.01 (default normalized score),

where (max(M)−min(M)==0) and (Mᵢ−min(M)==0).

As shown in FIG. 8, the table 800 includes a column 802 that lists the source code entities (E), a column 804 that lists sample metrics (M) for the number of other source code entities (each of which is linked to via inward edges in the source code graph model), and a column 806 that provides sample normalized scores (between 0 and 1) for each entity in the table.

Returning to FIG. 5, the code ranking engine 514 is responsible for the final categorization of Source Code level entities such as Class and Functions into business defined categories CAT1 (mission critical Class 1 type code) and CAT3 (being the low severity but good to have up and running Class 3 type). This engine 514 also provides relative ranking of the source entities based on their scores. In particular, the engine 514 takes the basis path occurrence score calculated from basis path analyzer module, the final weighted average score from graph analyzer module, and using the above two metrics, it classifies each Class/Function/Methods into 3 Categories, i.e., CAT1, CAT2 and CAT3. Using the above two metrics, the engine 514 generates a relative ranking of each Class/Function/Methods.

The final scoring function in Code Ranking Engine module is as defined below:

$$fs ( e ) = {\sum }_{n = 1}^{m} w * f ( st , sc ) ,$$

where:

ƒs is a function to calculate final score of source code entity e;

m represents the number of stages where sub scores were calculated;

w represents the individual weight of the score; and

ƒ(st, sc) is a function to calculate the sub-score sc for stage st.

The business rules and policies engine 512 is responsible for defining business rules and policies related to source code quality control and governance. Based on source code categorization from the code ranking engine, project management teams can define rules, such as:

Every change in a CAT1 Class/Function/Method has to be code reviewed by the Tech Lead (mandatorily);

Every change in a CAT1 Class/Function/Method has to be unit tested with 100% code coverage before it's checked into source control;

Every change in a CAT1 Class/Function/Method should have 0 complier warnings;

Every change in a CAT1 Class/Function/Method should have logging enabled at all levels (Error, Debug, Warning and Info);

Every change in a CAT2 Class/Function/Method has to be code reviewed by the Tech Lead (optionally) or peer (mandatorily);

Every change in a CAT2 Class/Function/Method has to be unit tested with at least 70% code coverage before it's checked into source control;

Every change in a CAT2 Class/Function/Method can have warnings ignored;

Every change in a CAT2 Class/Function/Method should have logging enabled at least at Error and Warning; and

CAT3 change might have less severe or stringent policies configured based on business scenario and org requirements.

The development teams' code changes, modifications and other development activities may be verified by business rules and policies engine 512 and if it violates any of the business or quality compliance rules then that change may be flagged as a possible violation. The technical lead, manager, or quality control can then pull out a report of all possible violations flagged daily, over a week, bi-weekly or monthly for possible rectification actions.

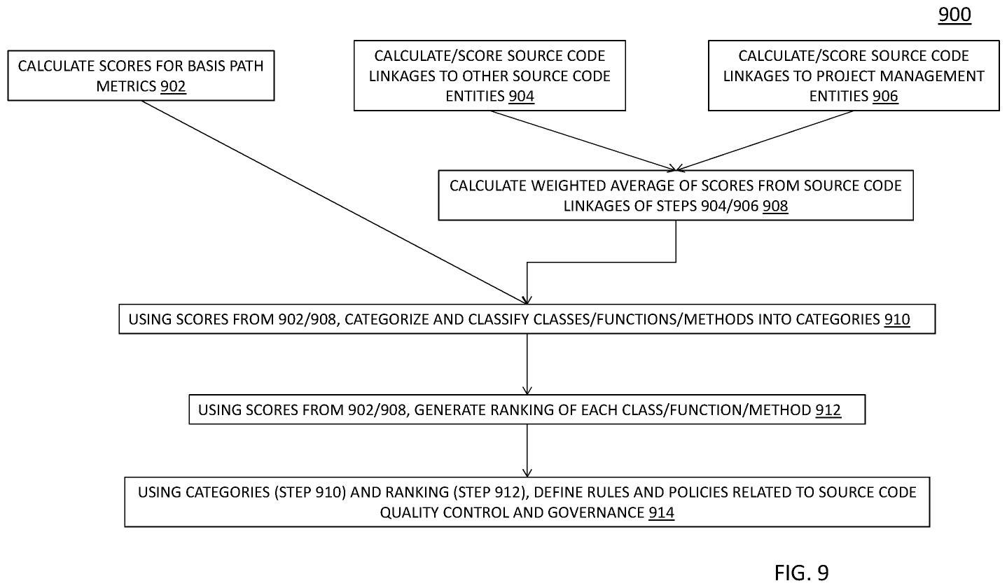

Turning now to FIG. 9, a flow diagram describing a process 900 for code ranking and categorization of entities will now be described.

In block 902, basis path metrics are calculated code ranking engine.

In block 904, source code entities (Class, Function, Method) are ranked based on their linkages with other source code entities.

In block 906, source code entities (Class, Function, Method) are ranked based on their linkages with other management entities, such as features, stories, tasks, defects, changesets). It will be understood that blocks 902-906 can be performed simultaneously or in succession. The system accesses the source code artifacts graph and project artifacts graph models to analyze and determine a ranking score for each class, function, and method. In embodiments, this is implemented by computing, e.g., that a given class is related by graph edges to a number of other entities. The more it is being referred to, the higher the ranking score.

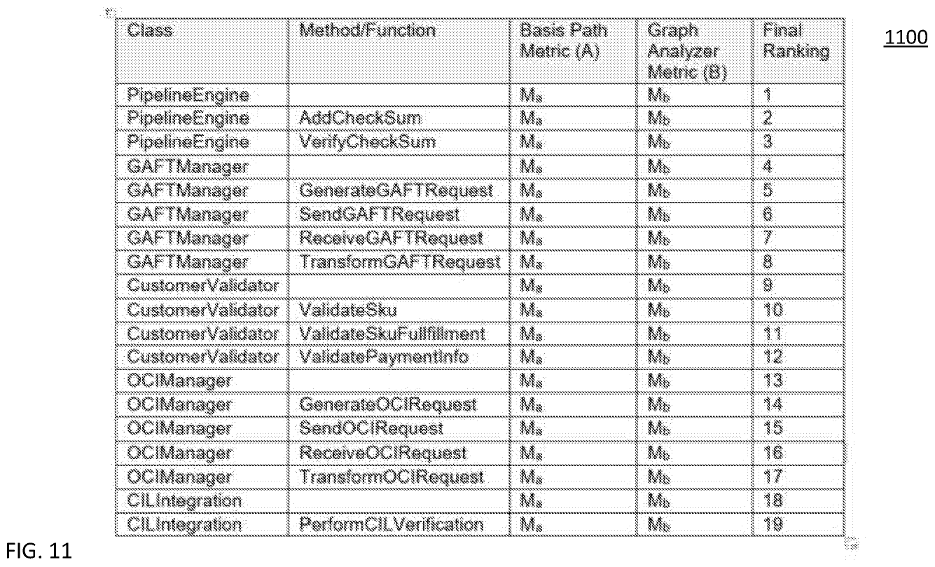

In block 908, a weighted average of the ranking scores (from blocks 902-906) is calculated by the code ranking engine, and a final score is allocated to each source code entity. In particular, the system takes a weighted average of the scores from blocks 904 and 906 allotted to a class, function, or method and calculates the final ranking score. A table 1100 in FIG. 11 illustrates sample classes along with corresponding metrics and final rankings.

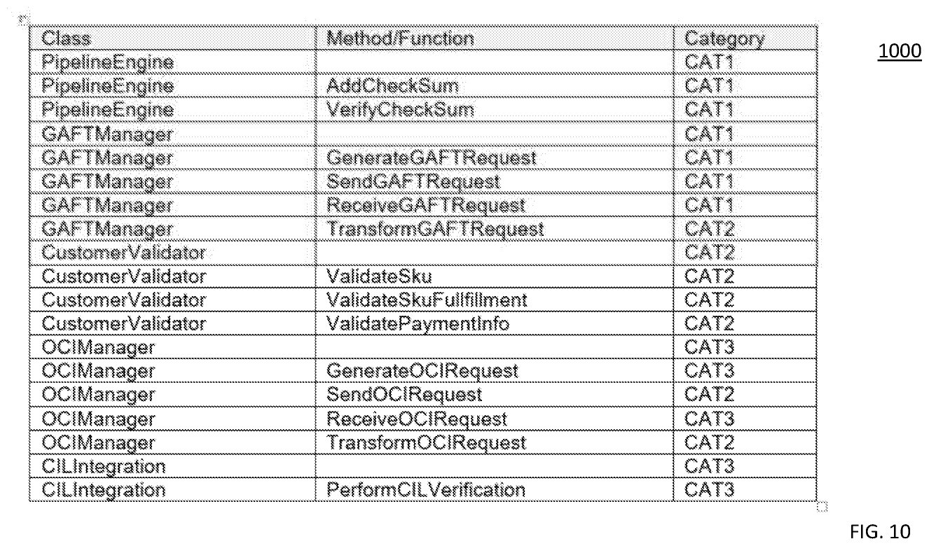

In block 910, the scores are used to classify and categorize each class/function/method into three categories (e.g., CAT1, CAT2, and CAT3). A table 1000 in FIG. 10 illustrates sample classes and categorizations.

In block 912, the source code ranking and categorization are used by business entities to define rules and policies related to source code quality control and governance. Technology and project management teams can define business rules based on the above rankings to enforce organization wide software quality control and governance policies.

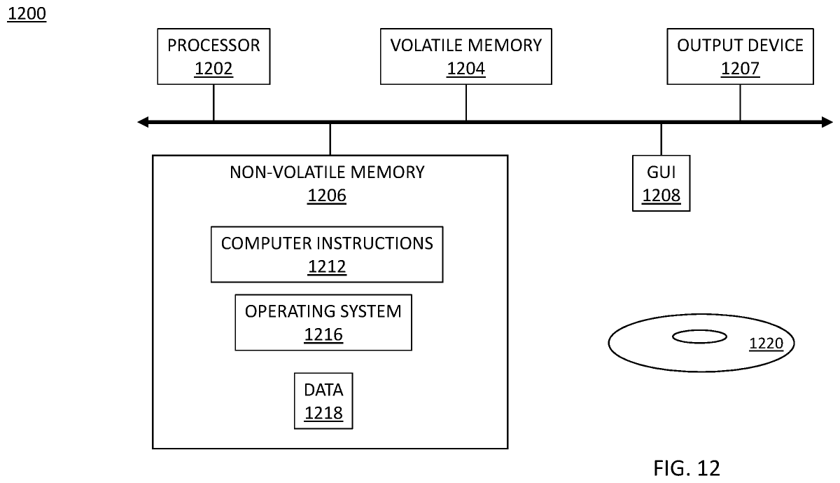

FIG. 12 shows an exemplary computer 1200 (e.g., physical or virtual) that can perform at least part of the processing described herein. The computer 1200 includes a processor 1202, a volatile memory 1204, a non-volatile memory 1206 (e.g., hard disk or flash), an output device 1207 and a graphical user interface (GUI) 1208 (e.g., a mouse, a keyboard, a display, for example). The non-volatile memory 1206 stores computer instructions 1212, an operating system 1216 and data 1218. In one example, the computer instructions 1212 are executed by the processor 1202 out of volatile memory 1204. In one embodiment, an article 1220 comprises non-transitory computer-readable instructions.

Processing may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer. Processing may also be implemented as a machine-readable storage medium, configured with a computer program, where upon execution, instructions in the computer program cause the computer to operate.

Processing may be performed by one or more programmable processors executing one or more computer programs to perform the functions of the system. All or part of the system may be implemented as, special purpose logic circuitry (e.g., an FPGA (field programmable gate array) and/or an ASIC (application-specific integrated circuit)).

Having described exemplary embodiments of the invention, it will now become apparent to one of ordinary skill in the art that other embodiments incorporating their concepts may also be used. The embodiments contained herein should not be limited to the disclosed embodiments but rather should be limited only by the spirit and scope of the appended claims. All publications and references cited herein are expressly incorporated herein by reference in their entirety.

Elements of different embodiments described herein may be combined to form other embodiments not specifically set forth above. Various elements, which are described in the context of a single embodiment, may also be provided separately or in any suitable subcombination. Other embodiments not specifically described herein are also within the scope of the following claims.

While illustrative embodiments have been described with respect to processes of circuits, described embodiments may be implemented as a single integrated circuit, a multi-chip module, a single card, or a multi-card circuit pack. Further, as would be apparent to one skilled in the art, various functions of circuit elements may also be implemented as processing blocks in a software program. Such software may be employed in, for example, a digital signal processor, micro-controller, or general-purpose computer. Thus, described embodiments may be implemented in hardware, a combination of hardware and software, software, or software in execution by one or more processors.

Some embodiments may be implemented in the form of methods and apparatuses for practicing those methods. Described embodiments may also be implemented in the form of program code, for example, stored in a storage medium, loaded into and/or executed by a machine, or transmitted over some transmission medium or carrier, such as over electrical wiring or cabling, through fiber optics, or via electromagnetic radiation. A non-transitory machine-readable medium may include but is not limited to tangible media, such as magnetic recording media including hard drives, floppy diskettes, and magnetic tape media, optical recording media including compact discs (CDs) and digital versatile discs (DVDs), solid state memory such as flash memory, hybrid magnetic and solid state memory, non-volatile memory, volatile memory, and so forth, but does not include a transitory signal per se. When embodied in a non-transitory machine-readable medium and the program code is loaded into and executed by a machine, such as a computer, the machine becomes an apparatus for practicing the method.

When implemented on a processing device, the program code segments combine with the processor to provide a unique device that operates analogously to specific logic circuits. Such processing devices may include, for example, a general purpose microprocessor, a digital signal processor (DSP), a reduced instruction set computer (RISC), a complex instruction set computer (CISC), an application specific integrated circuit (ASIC), a field programmable gate array (FPGA), a programmable logic array (PLA), a microcontroller, an embedded controller, a multi-core processor, and/or others, including combinations of the above. Described embodiments may also be implemented in the form of a bitstream or other sequence of signal values electrically or optically transmitted through a medium, stored magnetic-field variations in a magnetic recording medium, etc., generated using a method and/or an apparatus as recited in the claims.

Various elements, which are described in the context of a single embodiment, may also be provided separately or in any suitable subcombination. It will be further understood that various changes in the details, materials, and arrangements of the parts that have been described and illustrated herein may be made by those skilled in the art without departing from the scope of the following claims.

In the above-described flow charts of FIGS. 2-4, rectangular elements, herein denoted “processing blocks,” represent computer software instructions or groups of instructions. Alternatively, the processing blocks may represent steps performed by functionally equivalent circuits such as a digital signal processor (DSP) circuit or an application specific integrated circuit (ASIC). The flow diagram does not depict the syntax of any particular programming language but rather illustrate the functional information one of ordinary skill in the art requires to fabricate circuits or to generate computer software to perform the processing required of the particular apparatus. It should be noted that many routine program elements, such as initialization of loops and variables and the use of temporary variables may be omitted for clarity. The particular sequence of blocks described is illustrative only and can be varied without departing from the spirit of the concepts, structures, and techniques sought to be protected herein. Thus, unless otherwise stated, the blocks described below are unordered meaning that, when possible, the functions represented by the blocks can be performed in any convenient or desirable order.

Some embodiments may be implemented in the form of methods and apparatuses for practicing those methods. Described embodiments may also be implemented in the form of program code, for example, stored in a storage medium, loaded into and/or executed by a machine, or transmitted over some transmission medium or carrier, such as over electrical wiring or cabling, through fiber optics, or via electromagnetic radiation. A non-transitory machine-readable medium may include but is not limited to tangible media, such as magnetic recording media including hard drives, floppy diskettes, and magnetic tape media, optical recording media including compact discs (CDs) and digital versatile discs (DVDs), solid state memory such as flash memory, hybrid magnetic and solid state memory, non-volatile memory, volatile memory, and so forth, but does not include a transitory signal per se. When embodied in a non-transitory machine-readable medium and the program code is loaded into and executed by a machine, such as a computer, the machine becomes an apparatus for practicing the method.

When implemented on one or more processing devices, the program code segments combine with the processor to provide a unique device that operates analogously to specific logic circuits. Such processing devices may include, for example, a general purpose microprocessor, a digital signal processor (DSP), a reduced instruction set computer (RISC), a complex instruction set computer (CISC), an application specific integrated circuit (ASIC), a field programmable gate array (FPGA), a programmable logic array (PLA), a microcontroller, an embedded controller, a multi-core processor, and/or others, including combinations of one or more of the above. Described embodiments may also be implemented in the form of a bitstream or other sequence of signal values electrically or optically transmitted through a medium, stored magnetic-field variations in a magnetic recording medium, etc., generated using a method and/or an apparatus as recited in the claims.

In some embodiments, a storage medium may be a physical or logical device. In some embodiments, a storage medium may consist of physical or logical devices. In some embodiments, a storage medium may be mapped across multiple physical and/or logical devices. In some embodiments, storage medium may exist in a virtualized environment. In some embodiments, a processor may be a virtual or physical embodiment. In some embodiments, logic may be executed across one or more physical or virtual processors.

For purposes of illustrating the present embodiment, the disclosed embodiments are described as embodied in a specific configuration and using special logical arrangements, but one skilled in the art will appreciate that the device is not limited to the specific configuration but rather only by the claims included with this specification. In addition, it is expected that during the life of a patent maturing from this application, many relevant technologies will be developed, and the scopes of the corresponding terms are intended to include all such new technologies a priori.

The terms “comprises,” “comprising”, “includes”, “including”, “having” and their conjugates at least mean “including but not limited to”. As used herein, the singular form “a,” “an” and “the” includes plural references unless the context clearly dictates otherwise. Various elements, which are described in the context of a single embodiment, may also be provided separately or in any suitable subcombination. It will be further understood that various changes in the details, materials, and arrangements of the parts that have been described and illustrated herein may be made by those skilled in the art without departing from the scope of the following claims.

We claim:

1. A method for dynamic categorization and ranking of source code entities and relationships, the method comprising:
scanning source code of an application, extracting source code entities from the application, and generating a hierarchical source code entity graph model from extracted source code entities;
scanning a project management artifact repository, extracting project management artifacts from the project management artifact repository, and generating a hierarchical project management artifact graph model from extracted project management artifacts;
traversing the hierarchical source code entity graph model and the hierarchical project management artifact graph model, and identifying linking relationships between the source code entities and the project management artifacts;
defining a policy for software quality control from the linking relationships;
monitoring source code changes to the application; and
modifying source code development for the application when a violation of the policy is identified in response to the monitoring.

2. The method of claim 1, wherein the identifying linking relationships between the source code entities and the project management artifacts includes:
calculating a basis path metric score for each of the source code entities with respect to basis path metrics, the basis path metric score calculated as a function of a frequency in which the source code entity appears in basis paths during execution of the application at runtime.

3. The method of claim 2, wherein the identifying linking relationships between the source code entities and the project management artifacts further includes:
calculating a source code entity linking score for each of the source code entities with respect to others of the source code entities, the source code entity linking score calculated as a function of a frequency in which the source code entity is linked to the other source code entities via inward edges in the hierarchical source code entity graph model.

4. The method of claim 3, wherein the identifying linking relationships between the source code entities and the project management artifacts further includes:
calculating a project management artifact linking score for each of the source code entities with respect to linkages between the source code entity and one or more of the project management artifacts, the project management artifact linking score calculated as a function of a frequency in which each source code entity is linked to a corresponding project management artifact.

5. The method of claim 4, further comprising calculating a weighted average score of the basis path metric score, the source code entity linking score, and the project management artifact linking score, the weighted average score calculated based on business-defined system criteria.

6. The method of claim 4, further comprising categorizing classes, functions, and methods of the source code entities into relevance categories that indicate a business-defined relevance of the source code entities, and generating a ranking of each of the classes, functions, and methods.

7. The method of claim 1, wherein the source code entities include classes, functions, and methods, and the project management artifacts include features, defects, stories, and tasks.

8. A system for dynamic categorization and ranking of source code entities and relationships, the system comprising:
a memory comprising computer-executable instructions; and
a processor executing the computer-executable instructions, the computer-executable instructions when executed by the processor cause the processor to perform operations comprising:
scanning source code of an application, extracting source code entities from the application, and generating a hierarchical source code entity graph model from extracted source code entities;
scanning a project management artifact repository, extracting project management artifacts from the project management artifact repository, and generating a hierarchical project management artifact graph model from extracted project management artifacts;
traversing the hierarchical source code entity graph model and the hierarchical project management artifact graph model, and identifying linking relationships between the source code entities and the project management artifacts;
defining a policy for software quality control from the linking relationships;
monitoring source code changes to the application; and
modifying source code development for the application when a violation of the policy is identified in response to the monitoring.

9. The system of claim 8, wherein the identifying linking relationships between the source code entities and the project management artifacts includes:
calculating a basis path metric score for each of the source code entities with respect to basis path metrics, the basis path metric score calculated as a function of a frequency in which the source code entity appears in basis paths during execution of the application at runtime.

10. The system of claim 9, wherein the identifying linking relationships between the source code entities and the project management artifacts further includes:
calculating a source code entity linking score for each of the source code entities with respect to others of the source code entities, the source code entity linking score calculated as a function of a frequency in which the source code entity is linked to the other source code entities via inward edges in the hierarchical source code entity graph model.

11. The system of claim 10, wherein the identifying linking relationships between the source code entities and the project management artifacts further includes:
calculating a project management artifact linking score for each of the source code entities with respect to linkages between the source code entity and one or more of the project management artifacts, the project management artifact linking score calculated as a function of a frequency in which each source code entity is linked to a corresponding project management artifact.

12. The system of claim 11, wherein the operations further include calculating a weighted average score of the basis path metric score, the source code entity linking score, and the project management artifact linking score, the weighted average score calculated based on business-defined system criteria.

13. The system of claim 11, wherein the operations further include:
categorizing classes, functions, and methods of the source code entities into relevance categories, and generating a ranking of each of the classes, functions, and methods.

14. The system of claim 8, wherein the source code entities include classes, functions, and methods, and the project management artifacts include features, defects, stories, and tasks.

15. A computer program product for dynamic categorization and ranking of source code entities and relationships, the computer program product embodied on a non-transitory computer readable medium and including instructions that, when executed by a computer causes the computer to perform operations comprising:
scanning source code of an application, extracting source code entities from the application, and generating a hierarchical source code entity graph model from extracted source code entities;
scanning a project management artifact repository, extracting project management artifacts from the project management artifact repository, and generating a hierarchical project management artifact graph model from extracted project management artifacts;
traversing the hierarchical source code entity graph model and the hierarchical project management artifact graph model, and identifying linking relationships between the source code entities and the project management artifacts;
defining a policy for software quality control from the linking relationships;
monitoring source code changes to the application; and
modifying source code development for the application when a violation of the policy is identified in response to the monitoring.

16. The computer program product of claim 15, wherein the identifying linking relationships between the source code entities and the project management artifacts includes:
calculating a basis path metric score for each of the source code entities with respect to basis path metrics, the basis path metric score calculated as a function of a frequency in which the source code entity appears in basis paths during execution of the application at runtime.

17. The computer program product of claim 16, wherein the identifying linking relationships between the source code entities and the project management artifacts further includes:
calculating a source code entity linking score for each of the source code entities with respect to others of the source code entities, the source code entity linking score calculated as a function of a frequency in which the source code entity is linked to the other source code entities via inward edges in the hierarchical source code entity graph model.

18. The computer program product of claim 17, wherein the identifying linking relationships between the source code entities and the project management artifacts further includes:
calculating a project management artifact linking score for each of the source code entities with respect to linkages between the source code entity and one or more of the project management artifacts, the project management artifact linking score calculated as a function of a frequency in which each source code entity is linked to a corresponding project management artifact.

19. The computer program product of claim 18, wherein the operations further include calculating a weighted average score of the basis path metric score, the source code entity linking score, and the project management artifact linking score, the weighted average score calculated based on business-defined system criteria.

20. The computer program product of claim 18, wherein the operations further include:
categorizing classes, functions, and methods of the source code entities into relevance categories that indicate a business-defined relevance of the source code entities, and generating a ranking of each of the classes, functions, and methods; and
wherein the source code entities include classes, functions, and methods, and the project management artifacts include features, defects, stories, and tasks.
